(19) United States
(12) Patent Application Publication
(10) Pub. No.: US 2010/0133197 A1
(43) Pub. Date: Jun. 3, 2010

(54) APPARATUS FOR SEPARATING WASTE FROM CELLULOSE FIBRES IN PAPER RECYCLING PROCESSES

(76) Inventor: Herbert Gunther Joachim Langner, Brantford (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/452,727

(22) PCT Filed: Jul. 8, 2008
(86) PCT No.: PCT/CA2008/001262

§ 371 Date: Jan. 19, 2010

(30) Foreign Application Priority Data
Jul. 24, 2007 (CA) PCT/CA2007/001306

(51) Int. Cl. D21C 5/02; B01D 21/02; B01D 21/24; D21D 5/28; C02F 103/28

(52) U.S. Cl. 210/703; 210/150; 210/137; 210/109

(57) ABSTRACT

A contaminate separation apparatus for use in separating contaminant materials from cellulose and/or paper fibres in a paper recycling process includes a reservoir for receiving a waste paper slurry therein. The reservoir is provided with an inlet opening for the input of the slurry, one or more fibre discharge outlets or passages, and at least one waste outlet positioned vertically above the fibre discharge outlet opening. An agitator provided in a lower portion of the reservoir generates differential flow currents within the reservoir, to selectively divert plastics, waxes, adhesives and/or other sticky waste materials outwardly towards the waste outlet, while providing a flow of suspended paper and/or cellulose fibres to one or more of the fibre discharge outlets.

### SCOPE OF THE INVENTION

The present invention relates to an apparatus for use in a recycling process to separate waste and contaminant materials from fibrous materials, such as paper and cellulose fibres, and a method for using same.

### BACKGROUND OF THE INVENTION

The diversion of paper, cardboard and other cellulose-based products from municipal and commercial waste for use in the manufacture of recycled paper has been widely adopted as a method of reducing the volume of garbage and waste material to be landfilled. Approximately 60 to 70% of conventional paper waste such as newspapers, office letterhead, stationery, box board and/or cardboard is of a sufficiently high quality grade to enable its direct recycling for use in the remanufacturing of recycled paper products.

A significant portion of diverted paper waste, however, contains contaminants which hinder use in recycled paper manufacturing processes. For example, frequently paper waste includes contaminant materials such as gum labels, soluble and insoluble adhesives, hot melt glues, adhesive bindings, wax coatings, window envelopes and/or laminated papers and residues. The presence of such contaminant materials has heretofore resulted in a significant portion of diverted paper waste being deemed unsuitable for recycling applications, necessitating its incineration and/or landfill.

### SUMMARY OF THE INVENTION

The present invention seeks to provide an apparatus which may be economically manufactured and used to separate contaminants such as plastics, waxes, glues, adhesives and other such sticky residues from recycled waste paper or cellulose fibres for further use in paper recycling processes.

In another object, the present invention seeks to provide an improved system and method from removing contaminants from fibrous materials as part of a continuous separation process, and whereby separated fibres may be diverted for further processing or manufacture.

Another object of the invention is to provide a system for recycling paper waste which provides improved efficiencies in the separation of paper and/or cellulose fibres from plastics, adhesive residues and other contaminant materials present in the diverted waste material.

A further object of the invention is to provide an apparatus used for separating contaminant materials from cellulose fibres in a waste stream or slurry, and which may be economically operated and/or installed in conventional recycling and/or classification systems.

Another object of the invention is to provide a contaminant separation apparatus which is operable to separate contaminant material from cellulose fibres from a recycled paper slurry supplied to the apparatus as a substantially continuous flow.

To at least partially achieve some of the foregoing objects and/or overcome disadvantages of the prior art, the present invention provides for a contaminate separation apparatus for use in separating contaminant materials from fibrous materials, and preferably from cellulose and/or paper fibres in a paper recycling process. The apparatus includes a reservoir for receiving a liquefied slurry of waste, and more preferably diverted paper waste which is to be recycled therein. The reservoir is provided with one or more inlet openings for receiving a volume of the slurry, one or more fibre discharge outlets or passages, and at least one waste outlet. In one preferred construction, the waste outlet may be provided in a position spaced vertically above a fibre discharge passage opening.

An agitator is most preferably provided in a lower portion of the reservoir for use in generating differential flow currents within the reservoir. The differential flow currents are used to selectively divert plastics, waxes, adhesives and/or other waste materials outwardly from the reservoir towards the waste outlet, while providing a flow of suspended paper and/or cellulose fibres towards one or more of the fibre discharge outlets. Suitable agitators could, for example, include mechanical agitators, as well as fluid outlet nozzles of different diameters and/or configurations adapted to introduce different water, fluid and/or waste stream flows into the reservoir. In a most simplified construction, the agitator is provided as one or more gas outlets or nozzles which are selectively operable to supply a gas flow to a lower region of the reservoir, and most preferably at least to a bottom central region of the reservoir. The applicant has appreciated that the introduction of a gas flow into the reservoir advantageously results in the adhesive, waxes, plastics and other lower density contaminants being entrained with the gas bubbles to differentially move towards the upper regions of the reservoir, while the comparatively denser, longer paper and cellulose fibres tend to settle towards the reservoir sides.

In a most economical construction, air is provided as an agitating gas via the gas outlet, however, other gasses including, without restriction, oxygen, nitrogen and ineit gasses may also be used. Optionally, ozone may be introduced into the agitating gas flow to reduce bacterial activity within the gas nozzles and/or reservoir.

Most preferably, one or more fibre discharge passages are provided which extend from an inlet opening provided in fluid communication with the reservoir interior. The inlet opening is spaced remote from the agitator and intermediate the contaminant waste outlet and the inlet opening through which the waste paper slurry is introduced into the reservoir. Preferably one or more baffle members are provided which extend partway across the interior reservoir. The baffle members are positioned at least in part above and/or below one or more of the inlet openings of the discharge passages to assist in the diversion of paper and/or cellulose fibres into the filter discharge passages. Baffle members of various configurations may be used, including horizontal, planar and/or tubular or curved baffles. In one embodiment, a baffle is provided which extends about the interior periphery of the reservoir, and which has a substantially planar construction extending angularly downwardly immediately above the discharge passage inlet openings. In another possible embodiment, one or more baffle members may be provided about the reservoir interior, and which extend as a generally planar member angularly upwardly, immediately below the inlet openings.

In use, a fluidized waste stream or slurry is supplied into the reservoir, and most preferably into the lower region of the reservoir, in either a batch process or continuously. As the waste slurry is introduced into the reservoir, a gas such as nitrogen, oxygen or air and/or ozone is simultaneously introduced into the bottom of the reservoir via the gas outlet nozzles to generate an upward flow. The gas is provided with a preferred flow rate between about 0.1 and 2 cubic meters per minute, depending on the volume of the reservoir and the flow rate of the slurry therein. As the gas is introduced, the lower density contaminant materials tend to move with the gas bubbles upwardly towards the upper regions of the reservoir. The liquid along the top of the reservoir may thus be diverted together with the contaminant materials entrained therein into the waste outlet for disposal. Simultaneously, the paper and cellulose fibres in the slurry tend to settle towards the bottom of the reservoir, moving toward the lower reservoir sidewalls where they are diverted via the baffles into the fibre discharge passages.

In one aspect the present invention resides in an apparatus for separating contaminant material from paper or cellulose fibres in a waste stream slurry, the apparatus including,

a reservoir for receiving a volume of said slurry therein, said reservoir including a sidewall extending from a lower edge portion to an upper edge portion,

a slurry infeed opening providing fluid communication between a slurry supply and a lower region of said reservoir,

a contaminate waste outlet spaced toward said upper edge portion and in fluid communication with said reservoir,

at least one baffle member disposed in said reservoir and positioned intermediate said infeed opening and said waste outlet,

at least one fibre discharge passage providing fluid communication between an inlet opening proximate to a selected said baffle member and a discharge outlet spaced vertically above said inlet opening, and

a gas nozzle selectively operable to supply a gas flow to said lower region of said reservoir.

In another aspect, the present invention resides in use of a separation apparatus for separating contaminants from cellulose fibres in a slurry, the apparatus comprising,

a reservoir for receiving a volume of said slurry therein, said reservoir including a sidewall extending from a lower edge portion to an upper edge portion,

a slurry infeed opening providing fluid communication between a slurry supply and a lower region of said reservoir,

a waste outlet spaced toward said upper edge portion and in fluid communication with said reservoir,

at least one baffle member disposed in said reservoir and positioned intermediate said infeed opening and said waste outlet, at least one fibre discharge passage providing fluid communication between a passage inlet opening proximate to a portion of a selected said baffle member and a discharge outlet spaced vertically above said inlet opening, and

a gas nozzle selectively operable to supply a gas flow to said lower region of said reservoir,

and wherein said waste stream slurry comprises at least about 90% water and is fed into said reservoir through said infeed opening at a rate selected at between about 0.2 and 5 cubic meters per minute.

In a further aspect, the present invention resides in an apparatus for separating plastic and adhesive materials from paper fibres in a recycled paper waste slurry, the apparatus including,

a reservoir for receiving said slurry therein, said reservoir including a generally cylindrical sidewall extending along an axis from a lower edge portion to an upper edge portion,

an infeed opening through said sidewall and providing fluid communication between a slurry supply and a lower region of said reservoir,

a contaminant waste outlet spaced toward said upper edge portion and providing fluid communication between said reservoir and a waste discharge,

a baffle member disposed in said reservoir and projecting radially about said sidewall part way towards said axis, said baffle member being positioned intermediate said infeed opening and said waste outlet,

a plurality of fibre discharge passages, said discharge passages being radially spaced about said axis and providing fluid communication between a respective passage inlet opening proximate to either an underside or top side of said baffle member, and a discharge channel spaced vertically a distance above the passage inlet opening,

a gas nozzle selectively operable to supply a gas flow to said lower region of said reservoir.

In yet another aspect, the present invention resides in an apparatus for separating contaminant material from fibrous material in a waste stream slurry, the apparatus including,

a reservoir for receiving a volume of said slurry therein, said reservoir including a sidewall extending from a lower edge portion to an upper edge portion,

a slurry infeed opening providing fluid communication between a slurry supply and a lower region of said reservoir,

a contaminate waste outlet spaced toward said upper edge portion and in fluid communication with said reservoir,

at least one baffle member disposed in said reservoir and positioned intermediate said infeed opening and said waste outlet,

a plurality of fibre discharge passages, said discharge passages providing fluid communication between a respective inlet opening formed in said sidewall proximate to an upper surface of a selected one of said baffle members, and a passage outlet spaced vertically above said inlet opening, and

a gas nozzle assembly selectively operable to supply a gas flow to said lower region of said reservoir.

### BRIEF DESCRIPTION OF THE DRAWINGS

Reference may now be had to the following detailed description taken together with the accompanying drawings in which:

FIG. 1 illustrates schematically a system for the removal of contaminate materials from paper waste in a paper recycling process, in accordance with a first embodiment of the invention;

FIG. 2 shows a perspective view of a contaminant separation apparatus used to separate contaminant materials from paper fibres in operation of the system of FIG. 1;

FIG. 3 shows a perspective top view of the apparatus of FIG. 2;

FIG. 4 illustrates a perspective front view of the apparatus of FIG. 2;

FIG. 5 illustrates schematically an enlarged cross-sectional view of the apparatus of FIG. 2 taken along lines 5-5 in operation;

FIG. 6 shows a perspective view of a contaminant separation apparatus for use in the system of FIG. 1, in accordance with another embodiment of the invention;

FIG. 7 illustrate schematically a side view of the containment separation apparatus of FIG. 6; and

FIG. 8 illustrates schematically a top view of the contaminate separation apparatus as shown in FIG. 7.

### DETAILED DESCRIPTION OF THE PREFERRED EMBODIMENTS

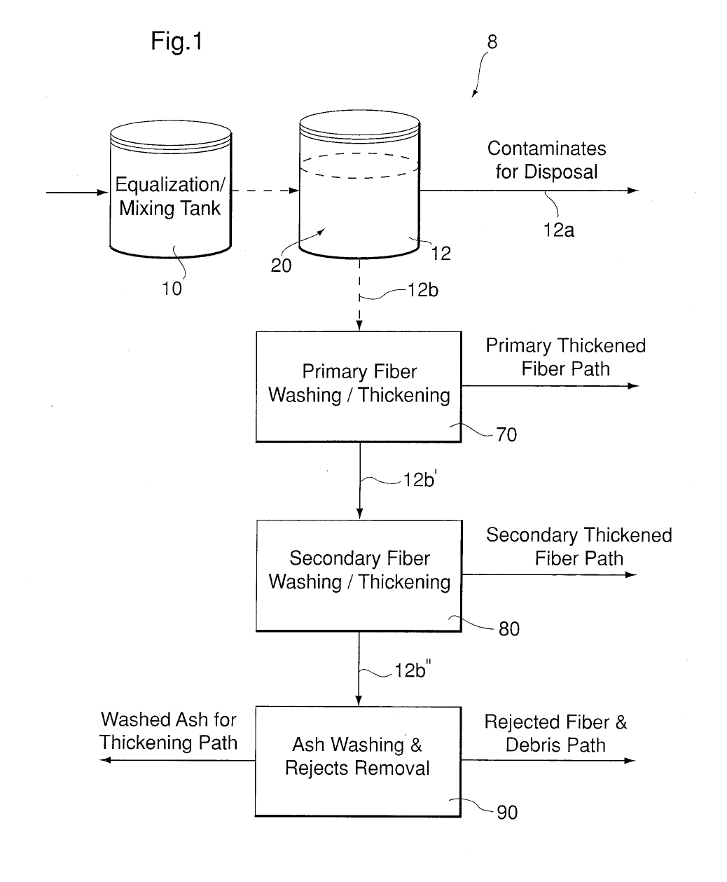

FIG. 1 illustrates schematically a system 8 used in the removal of contaminant material such as plastics, adhesives, wax residues, hot melt glues and binding remnants from paper fibres in waste paper, which has been diverted from municipal and/or commercial waste streams for recycling as remanufactured paper products. In the embodiment shown, the system 8 includes a homogenizing or mixing tank 10, a contaminant separation apparatus 20, a primary fibre washing/thickening station 70, a secondary fibre washing/thickening station 80, and a residual ash removal station 90. Suitable washing/thickening stations 70,80 and ash removal station 90 include, for example, conventional rotating screening apparatus similar to the type which, for example, are disclosed in issued Canadian Patent No. 2,182,833 to Langner. The liquid material and suspended solids are fed into the interior of a rotating screening cylinder to effect filtration and separation of particulate material from the water filtrate.

As will be described, most preferably the system 8 operates as a substantially continuous flow process. It is to be appreciated, however, that in a less preferred mode of operation, the system 8 could be operated either partially or in entirety as a batch operation.

Initially, diverted paper material is shredded and fed into a mixing tank 10 where it is mechanically admixed with water to form a homogenous slurry 12. Most preferably, the slurry 12 is formed having a water content selected at between about 90 and 98%, and more preferably between about 96 and 97%.

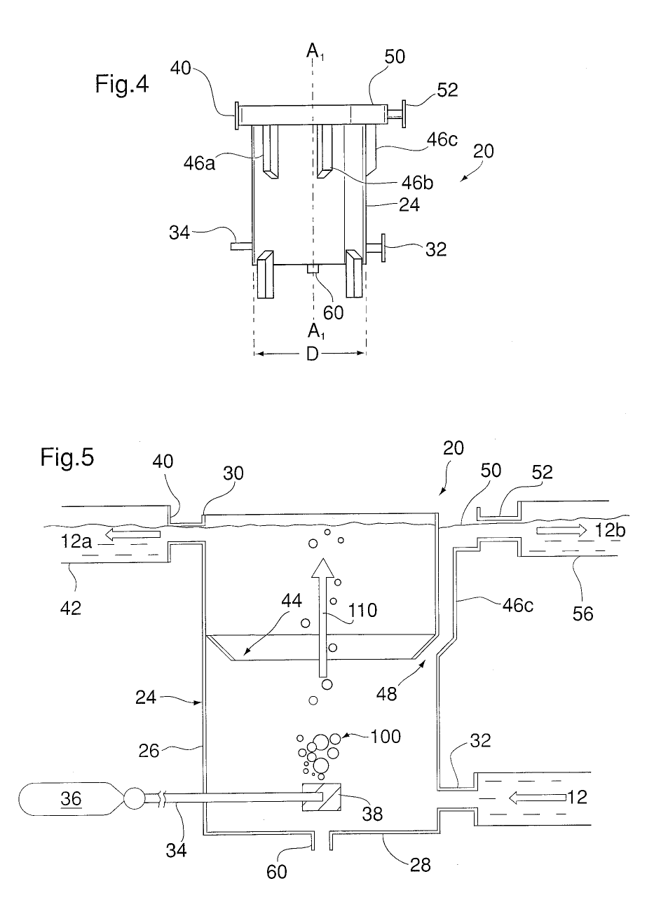

Following its homogenization, the slurry 12 is pumped from the mixing tank 10 into the contaminant separation apparatus 20 which is used to classify the slurry 12 into separately fluidized streams, one stream (12a) containing primarily separated contaminate material, and the other stream (12b) containing primarily paper fibres (FIG. 5). The fluid stream 12b containing the purified paper fibre/water mixture is then fed initially into the primary fibre washing/thickening station 70. The station 70 is used to initially separate larger paper fibres from the infed water/fibre stream 12b for use in the formation of remanufactured paper and/or other recycled paper products. In this regard, the station 70 preferably incorporates a screening drum selected for the primary diversion of larger paper fibres having a length selected greater than 750 microns. These collected primary fibres may then be sold to a mill for use in recycled paper manufacture.

The resulting filtrate 12b′ from station 70 is then fed by way of fluid pump (not shown) to the secondary washing/thickening station 80. Station 80 is used to extract smaller paper fibres from the filtrate 12b′ which have a fibre length greater than 150 microns for use as boiler feed, or in manufacturing and/or recycling.

Final processing of the filtrate 12b″ from the secondary washing/thickening station 80 occurs in the ash removal station 90. In station 90, ash is removed and cleaned for use as fertilizer and/or additives in cementaceous products such as portland cement. Any remaining contaminants in the station 90 are collected for disposal.

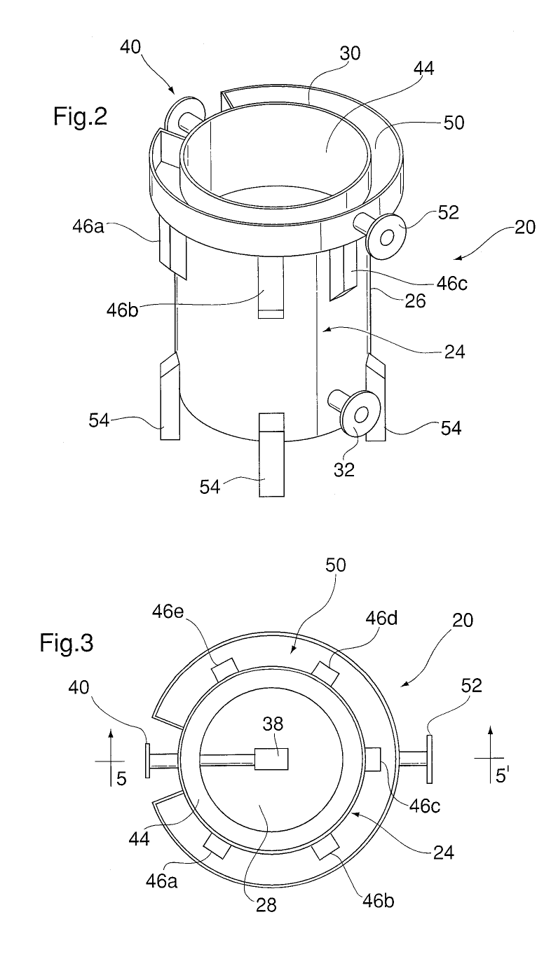

FIGS. 2 to 5 illustrate best the contaminant separation apparatus 20 used in the system 8 in accordance with a first embodiment of the invention. The apparatus 20 includes reservoir tank 24 having a generally cylindrical sidewall 26 and which is sealingly closed at its lowermost end by bottom panel 28 (FIG. 3). The sidewall 26 extends radially about a central axis A₁-A₁ (FIG. 4) to provide the tank 24 with a radial diameter D selected at between about 0.5 and 5 meters, preferably about 1 and 3 meters, and most preferably about 1.5 meters. The sidewall 26 extends in the axial direction from the bottom panel 28 to an uppermost lip 30, a vertical height of between about 0.5 to 5 meters, preferably 1 to 3 meters, and most preferably about 2 meters.

FIGS. 3 and 4 illustrate best the apparatus 20 as including a fluid infeed pipe 32 which extends through the sidewall 26 immediately adjacent the panel 28. The infeed pipe 32 provides fluid communication between the mixing tank 10 and interior of the reservoir tank 24. The infeed pipe 32 is sized to allow the waste stream slurry 12 to be fed into the apparatus 20 in a substantially continuous flow manner.

An air supply tube 34 (FIG. 4) furthermore is provided through the sidewall 26 adjacent the bottom panel 28. As shown best in FIG. 5, the air supply tube 34 provides gaseous communication between a pressurized air source 36 and a bubble diffuser 38 which is provided immediately adjacent the bottom panel 28 aligned with the reservoir axis A₁-A₁. The pressurized air source 36 is selectively operable to supply pressure in air flow to the interior of the tank 24 via the bubble diffuser 38 at a gas flow rate selected at between about 0.2 and 5 cubic meters per minute, preferably about 0.3 to 1 cubic meters per minute, and most preferably about 0.75 meters per minute, depending upon the rate of inflow of the slurry 12 into the bottom of the reservoir tank 24.

FIGS. 3 and 4 furthermore show best the reservoir tank 24 as including a contaminate waste discharge port 40 formed through the sidewall 26 spaced immediately below the upper lip 30. The discharge port 40 is provided in fluid communication with a waste discharge pipe 42 (FIG. 5) which is used to convey a waste fluid stream 12a containing plastics, adhesive residues and other contaminate material separated from the slurry 12 for disposal by landfill and/or incineration.

FIGS. 3 and 5 show best an annular baffle or flange member 44 as being disposed about the interior of the sidewall 26. The annular flange member 44 projects from the sidewall 26 radially inwardly towards the axis A₁-A₁, and downwardly at an angle selected at between about 30 and 60° and more preferably about 45° relative to the sidewall 26. The flange member 44 has a length selected at between about 4 and 40 cm, and more preferably about 15 to 20 cm.

As shown best in FIGS. 2 and 5, a series of fibre discharge passages 46a,46b,46c,46d,46e are provided at radially spaced locations about the sidewall 26. Each discharge passage 46 extends respectively from a passage inlet opening 48 vertically upwardly along the outside of the sidewall 26, opening into the bottom of a launder ring 50. The inlet openings 48 are formed through the sidewall 26 approximately one-third to two-thirds, and preferably about half of the distance from the bottom panel 28 to the lip 30. In one construction, the openings 48 are each located immediately adjacent to an underside of the flange member 44, with each discharge passage 46 extending generally vertically therefrom with a length of at least about 10 cm, and most preferably between about 30 and 100 cm.

The launder ring 50 is preferably provided as a U-shaped channel which extends radially about the uppermost lip 30 of the sidewall 26. The lower extent of the launder ring 50 is provided vertically adjacent to the waste discharge port 42. The launder ring 50 opens along a side of the reservoir tank 24 to a discharge outlet 52 for the paper fibre stream 12b. The fibre discharge outlet 52 is most preferably radially opposed to contaminate discharge port 40. Although not essential, the reservoir tank 24 may be mounted on leg supports 54 so that the tank's central axis A₁-A₁ is inclined at an angle of between about 2 and 7.5° relative to the vertical towards the discharge outlet 52. As a result, the lower extent of the discharge outlet 52 locates between about 0.2 and 10 cm, and preferably 0.2 cm and 0.4 cm below the lower extent of the waste discharge port 40. Piping 56 (FIG. 5) provides fluid communication between the discharge outlet 52 and the primary washing/thickening station 70 to convey the fluid stream 12b containing paper fibres separated from the slurry 12 for further processing.

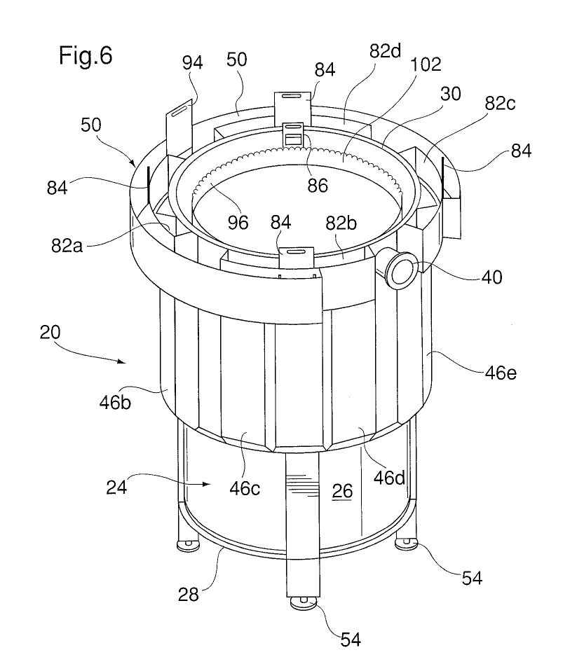

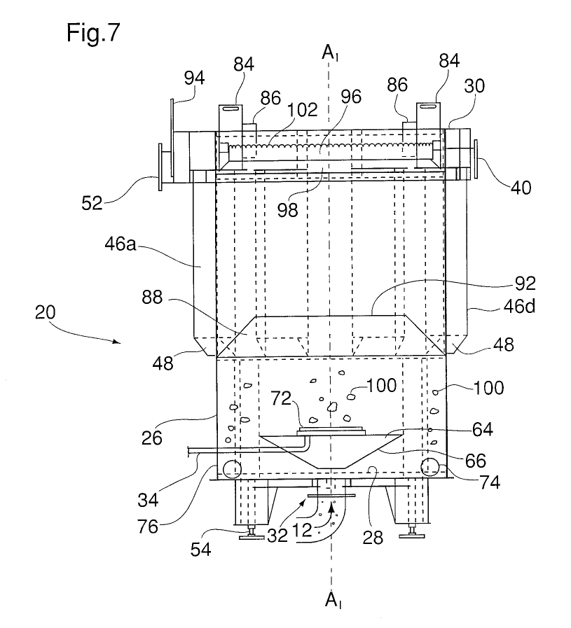

Optionally, as will be described with reference to FIGS. 6 and 7, one or more vertically movable sealing or gate members may be provided across the discharge port 40 and/or fibre discharge outlet 52. The gate members may be selectively raised or lowered to effect a change in the bottom flow path through the contaminant waste discharge port 40 and/or the discharge outlet 52 to permit balancing and/or adjustment of the flow therethrough.

Optionally, a cleanout drain 60 may be provided in the bottom panel 28. The cleanout drain 60 allows the reservoir tank 24 to be drained for periodic cleaning and/or maintenance.

In use of the apparatus 20, a homogenized waste slurry 12 having a water content of between 95 and 98%, and most preferably about 97% is pumped, or more preferably fed under gravity, from the mixing tank 10 to the reservoir tank 24. The slurry 12 is fed into the reservoir tank 24 through the infeed pipe 32 at a preferred continuous flow rate of about 2 cubic meters per minute. Simultaneously, as the waste slurry 12 is fed into the reservoir tank 24, the pressurized air source 36 is operated. The air source 36 provides a continuous stream of air into the bottom of the reservoir 24 via bubble diffuser 38 with a flow volume of between about 0.1 and 1 cubic meters per minute. The introduced air bubbles (shown as 100 in FIG. 5) rise vertically through the slurry 12 generally along the axis A₁-A₁ in the direction of arrow 110. As the gas bubbles 100 rise in the reservoir tank 24, contaminant material in the slurry 12, such as plastics, waxes and other glues and adhesive residues, are entrained with the rising bubbles 100. As a result, the contaminate material travels in an upward axially centered flow path, so as to move upwardly past the flange member 44. Concurrently, heavier paper fibres tend not to rise with the bubbles 100, moving towards the lower edges of the sidewall 26. The continuous flow of additional waste slurry 12 into the bottom of the reservoir tank 24, results in the contaminate material moving upwardly and then flowing as part of a waste flow stream 12a, outwardly from the apparatus 20 via the waste discharge port 40 and pipe 42.

Simultaneously, paper fibres are left behind as they tend not to be entrained with air bubbles 100. The result is that the paper fibres are concentrated and collect along the periphery of the sidewall 26. The continued inward movement of waste slurry 12 into the bottom portion of the reservoir tank 24 causes the flow of paper fibres to move upwardly against the underside of the flange member 44. Continued fluid flow results in a fluid stream 12b containing paper fibres with reduced concentrations of contaminant materials to move into the inlet openings 48 of the fibre discharge passages 46a,46b,46c,46d,46e and upwardly therealong into the launder ring 50. The fluid flow 12b containing paper fibres thus travels along the discharge passages 46 into the launder ring 50, flowing outwardly therefrom into the piping 56 via the discharge outlet 52.

The applicant has appreciated that the present apparatus 20 permits the removal of plastics, adhesives and other contaminants from recycled paper waste without requiring expensive filtration, or the use of mechanical screening and/or pumps. Accordingly, the apparatus 20 may be economically operated and is ideally suited for large scale paper processing and recycling operations.

Although FIGS. 2 to 5 illustrate the reservoir tank 24 as having a single annular baffle or flange member 44, the invention is not so limited. It is to be appreciated that additional baffle members of various shapes and sizes could also be provided, or baffles omitted in their entirety. Similarly, it is envisioned that fibre discharge passages 46 having differing shapes and/or configurations alone, or in combination with flange or baffle members of different profiles could also be used, without departing from the spirit and scope of the invention.

Reference may be had to FIGS. 6 to 8 which illustrate a containment separation apparatus 20 in accordance with a further embodiment of the invention, wherein like reference numerals are used to identify like components. The apparatus 20 shown is adapted to accommodate a larger volume of slurry and has a diameter D of about 2.25 meters and a vertical height of about 3.5 meters.

FIG. 6 illustrates the apparatus 20 as including a generally cylindrical reservoir tank 24 which is mounted on four adjustable leg supports 54. The reservoir tank 24 is provided with a sidewall 26 which extends radially about a central axis A₁-A₁ (FIG. 7) from bottom panel 28 to the uppermost lip 30.

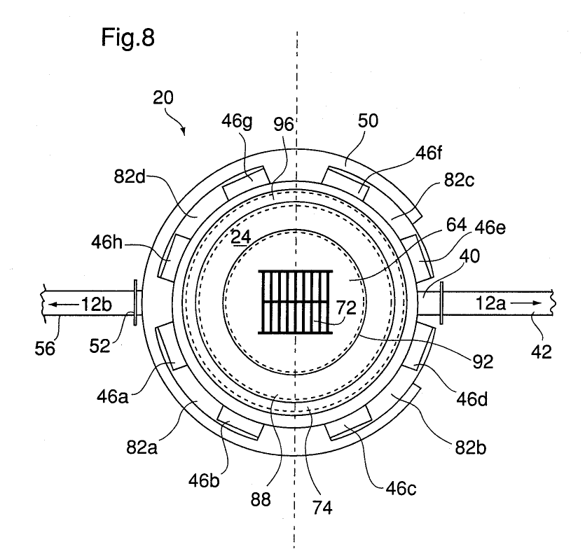

As shown best in FIGS. 7 and 8, the infeed extends through an axially centre portion of the bottom panel 28. As a result, slurry 12 is fed into the reservoir tank 24 via the infeed pipe 32 directly along the tank central axis A₁-A₁. A conical flow diverter 64 is preferably positioned immediately above and adjacent to the infeed pipe 32. The flow diverter 64 is provided with a generally conical lowermost surface 66 which extends radially about and orthogonal to the reservoir axis A₁-A₁. Most preferably, the conical surface 66 is configured to redirect the flow of the infed slurry 12 radially and evenly towards the reservoir sidewall 26 as a substantially even flow.

FIG. 7 shows best the air supply tube 34 as providing gaseous communication between the pressurized air source (shown as 36 in FIG. 5) and a pair of bubble diffusers 72,74. The bubble diffuser 72 is mounted to an upper surface of the flow diverter 64 to provide a centralized gas flow generally aligned with the reservoir axis A₁-A₁. Bubble diffuser 74 is provided as a generally circular, ring-shaped diffuser. Preferably, the bubble diffuser 74 has a diameter selected marginally less than the reservoir diameter D, so as to provide a secondary gas flow along the entire periphery of the reservoir sidewall 26. Optimally bubble diffusers 72 and/or 74 are coupled to the air supply tube 34 by means of a quick connect coupling 76 to allow for the rapid repair or replacement of either diffuser 72,74 in the event of clogging or fouling by bacteria.

In alternate configurations, the bubble diffuser 72 may be provided on the conical flow diverter 64 as a preassembled modular unit which is adapted for simplified replacement when needed. Similarly, a number of separate or segmented diffusers may be provided in place of the ring diffuser 74.

Although not essential, where the accumulation of bacteria is of a concern, the pressurized gas source 36 (FIG. 5) may be configured to either selectively or continuously supply ozone gas to the reservoir 24 via diffuser 72 and/or 74 to reduce and/or eliminate bacteria, mould and the like.

FIG. 7 shows best the separation apparatus 20 as including an annular baffle or flange member 88 positioned approximately 1.5 meters from the bottom panel 28. The annular flange 88 is formed as a generally planar member which projects inwardly from the sidewall 26. The flange member 88 extends radially inwardly and upwardly towards the axis A₁-A₁ at an angle of between about 25° and 75° from the axis A₁-A₁, and most preferably at an angle of approximately 45°. The flange member 88 has a preferred length selected at between 4 and 40 cm, and most preferably between about 15 and 30 cm, so as to define an axially centred neck portion 92 within the interior of the reservoir tank 24. Although not essential, most preferably the neck portion 92 is aligned directly above and has a diameter substantially corresponding to the maximum diameter of the conical flow diverter 64.

FIGS. 7 and 8 show best the apparatus 20 as including four pairs of fibre discharge passages 46a,b,46c,d,46e,f,46g,h. Each of the discharge passages 46a-h are elongated and extend in general alignment with axis A₁-A₁. The fibre discharge passages 46a-h are provided at equally radially spaced locations about the periphery of the sidewall 26. In the embodiment shown, the respective pairs of discharge passages 46a,b,46c,d,46e,f,46g,h extend upwardly from a respective passage inlet opening 48a-h to an upper end which opens into the bottom of a respective equalization chamber 82a,82b,82c,82d. FIG. 7 shows best the inlet openings 48 as being formed through the sidewall 26 immediately above the junction between the flange member 88 and the sidewall 26. Although not essential, most preferably the discharge passages 46 are provided with a size selected such that the total cross-sectional area of the discharge passages 46 is at least 80%, and more preferably is approximately equal to the cross-sectional surface area of the reservoir sidewall 26.

FIG. 6 shows best the flow equalization chambers 82 as selectively providing fluid communication with both the launder ring 50 and the interior of the reservoir tank 24. Each flow equalization chamber 82 is provided with a vertically adjustable fibre discharge gate 84. The discharge gate 84 is operable to be selectively raised or lowered to regulate the flow from the flow equalization chamber 82 into the launder ring 50 and outwardly via the discharge outlet 52. In addition, a vertically adjustable containment discharge gate 86 is provided at a location vertically spaced above the discharge gate 84. The discharge 86 is positioned to permit the return flow of any containments which may have moved into the discharge passages 46 to flow from equalization chamber 82 back into the interior of the reservoir tank 24. Although not essential, the fibre discharge gate 84 and containment discharge gate 86 are provided in a central portion in each flow equalization chamber between each respective pair of fibre discharge passages 46a,b,46c,d,46e,f,46g,h. This positioning advantageously permits the optimal balancing of flow between the discharge passages 46 of each pair, as well as the containment waste discharge port 40 and fibre discharge outlet 52.

FIGS. 6 and 7 show best the separation apparatus 20 as additionally including an outlet gate 94 for regulating fluid flow from the launder ring 50 outwardly into the pipe 56 via the discharge outlet 52.

FIGS. 6 and 7 show best a weir member 96 as being disposed about the interior of the sidewall 26 adjacent to the uppermost lip 30. The weir member 96 includes an angular portion 98 which extends radially inwardly and upwardly from the sidewall immediately adjacent the lowermost extent of the waste discharge port 40. At its upper end, the angular portion 98 merges with an upright ring portion 102 which is generally vertically aligned. Most preferably the ring portion 102 is roughly concentric with and is spaced inwardly from the sidewall 26 by a separation distance of between about 5 and 20 cm. The uppermost edge of the ring portion 102 is formed having a profile which is notched, scalloped, castellated, toothed or the like (hereinafter generally referred to as a “toothed profile”). The applicant has appreciated that providing the ring portion 102 with an uppermost edge having a toothed profile avoids the formation of a contaminate pancake across the open top of the reservoir tank 24. In particular, the formation of a containment pancake otherwise may inhibit the flow of waste materials outwardly from the reservoir 24 via the waste discharge port 40. Most preferably, the toothed profile of the ring portion 102 is formed such that the lower most extent of the tooth cut is provided at a vertical level which is at or equal to the uppermost extent of the waste outlet 40. In an alternate construction, the weir member 96 may be inclined relative to the vertical, to slope in a general orientation towards the waste outlet 40, to assist in directing the flow of containment materials thereto.

The use of the apparatus shown in FIGS. 6 to 8 occurs in essentially the same manner as that described with reference to FIG. 5. A homogenized waste slurry 12 with a preferred water content of between about 95% and 98% is pumped or fed from a mixing tank 10 (FIG. 1) into the reservoir tank 24 via infeed pipe 32 under a continuous flow. As the slurry 12 enters the reservoir tank 24, it is deflected radially towards the sidewall 26 by contact with the conical surface 66 of the flow diverter 64. Concurrently, the air source 36 (FIG. 5) provides a continuous stream of air into the lower portion of the reservoir tank 24 by way of bubble diffusers 72,74. Induced air bubbles 100 rise vertically through the slurry 12 generally along both the central axis A₁-A₁ and along the periphery of the sidewall 26, carrying plastics and other containment adhesives and residues therewith.

As additional slurry 12 enters the reservoir 24 and moves upwardly, heavier cellulose and paper fibres are directed towards the sidewall 26 and pass through the neck portion 92. As the fibres more vertically past the flange 88, the resulting drop in flow carries the cellulose and paper fibres to drop downwardly along the flange 88 and flow into the fibre discharge passages 46. The continuous flow of materials thus forces the cellulose/paper fibres upwardly along the discharge passages 46a-h and outwardly therefrom into the flow equalization chambers 82.

In the flow equalization chambers 82 any containment materials which have moved into the fibre discharge passages 46 rise to the upper portion of each chamber 82 and pass outwardly therefrom via the containment discharge gate 86, returning back into the reservoir tank 24 where they are redirected by the weir member 96 to the waste discharge port 40. The heavier fibre materials move from the flow equalization chambers 82 past the fibre discharge gate 84 and into the launder ring 50 for the diversion from the apparatus 20 outwardly by way of fibre discharge outlet 52 and pipe 56.

Concurrently, as the slurry 12 is fed into the apparatus, the containment material is entrained with the air bubbles 100 from the diffusers 72,74. Containments rise with the air bubbles 100, moving upwardly in the reservoir tank 24 and over the top of the ring portion 102 if weir member 96. The toothed profile of the ring portion 102 acts to break-up the containment layer along the top of the reservoir 24, minimizing any pancake formation. As the containment material moves over the ring portion 102, it flows downwardly along the angular portion 98 of the weir member 96, where it is redirected into the waste discharge pipe 46, via waste outlet port 40.

Although the preferred embodiment describes and illustrates the reservoir 24 as having a generally cylindrical sidewall construction, the invention is not so limited. It is to be appreciated that the present apparatus could equally be provided with a number of different sidewall 26 configurations including, without restriction, sidewalls having a generally square, oval or spherical cross-sectional profile.

Although the detailed description describes the contaminant separation apparatus 20 as used in a paper recycling process for the separation of waxes, glues plastics and adhesive residues, and the like from paper fibres, the invention is not so limited. It is to be appreciated that the apparatus 20 may be used in the separation of contaminants or other undesired materials in a variety of manufacturing, waste treatment and/or classification processes. By way of non-limiting example, such applications could include the treatment of pulp waste, other chemical industries or purification systems, food-manufacturing applications, as well as other liquid waste treatment processes.

Although the detailed description describes and illustrates various preferred aspects, the invention is not so limited. Many modifications and variations will now occur to persons skilled in the art. For a definition of the invention, reference may be had to the appended claims.

1. An apparatus for separating contaminant material from fibrous material in a waste stream slurry, the apparatus including,
a reservoir for receiving a volume of said slurry therein, said reservoir including a sidewall extending from a lower edge portion to an upper edge portion,
a slurry infeed opening providing fluid communication between a slurry supply and a lower region of said reservoir,
a contaminate waste outlet spaced toward said upper edge portion and in fluid communication with said reservoir,
at least one baffle member disposed in said reservoir and positioned intermediate said infeed opening and said waste outlet,
a plurality of fibre discharge passages, said discharge passages providing fluid communication between a respective inlet opening formed in said sidewall proximate to an upper surface of a selected one of said baffle members, and a passage outlet spaced vertically above said inlet opening, and
a gas nozzle assembly selectively operable to supply a gas flow to said lower region of said reservoir.

2. The apparatus as claimed in claim 1 wherein each passage outlet is in fluid communication with a fibre discharge outlet spaced vertically between about 0.5 and 5 cm below said waste outlet.

3. (canceled)

4. The apparatus as claimed in claim 1 wherein said reservoir extends along a generally central axis, wherein the selected baffle member comprises a generally annular baffle extending radially inwardly and upwardly from said sidewall towards said axis at an angle from vertical selected at between about 25° and 70°, and preferably between 30° and 60°.

5. The apparatus as claimed in claim 4 wherein the apparatus includes a plurality of pairs of said fibre discharge passages, said fibre discharge passages being generally vertically aligned with said axis and disposed at substantially equal radially spaced locations about said sidewall.

6. The apparatus as claimed in claim 5 wherein the passage outlets of each pair of discharge passages are open to a respective flow equalization chamber, each flow equalization chamber having a chamber outlet in fluid communication with a fibre discharge outlet.

7. The apparatus as claimed in claim 6 wherein each flow equalization chamber further includes a vertically adjustable gate member for selectively regulating fluid flow from the flow equalization chamber to the fibre discharge outlet.

8. The apparatus as claimed in claim 6 wherein each flow equalization chamber further includes an adjustable contaminate discharge port for permitting the return flow of said contaminant material from said equalization chamber back into said reservoir.

9. (canceled)

10. The apparatus as claimed in claim 1 wherein said sidewall comprises a generally cylindrical sidewall extending radially about a generally central axis, and said at least one baffle member including an annular baffle extending radially and upwardly inwardly from an edge portion proximate said sidewall, to an upper distal edge remote therefrom at an angle of between about 25° and 75° relative to said axis.

11. The apparatus as claimed in claim 1, further including a pumping assembly for supplying said slurry to said reservoir as a substantially continuous flow selected at between about 0.5 and 5 cubic meters per minute.

12. (canceled)

13. The apparatus as claimed in claim 1 further including a pressurized gas source for supplying said gas flow at a flow rate selected at between about 0.1 and 1.0 cubic meters per minute.

14. The apparatus as claimed in claim 10 wherein said sidewall is a generally cylindrical sidewall having a diameter between about 0.5 and 5 meters, and an axial length selected at between about 1 and 3 meters, the fibre discharge passages having a vertical length selected at least half as long as the axial length of the reservoir.

15. The apparatus as claimed in claim 10 wherein the fibre discharge passages have a size selected such that the cross-sectional surface area of the fibre discharge passages is at least 80% of the cross-sectional surface area of the reservoir.

16. The apparatus as claimed in claim 10 wherein the infeed opening is generally aligned with said vertical axis, the apparatus further including a flow diverter spaced vertically adjacent to said infeed opening, the flow diverter presenting at least one oblique surface for redirecting said waste stream slurry in a substantially even radial flow towards said sidewall.

17. (canceled)

18. The apparatus as claimed in claim 16 wherein said gas nozzle assembly includes a primary gas diffuser generally aligned with said central axis and at least one secondary gas diffuser,
the primary diffuser being spaced vertically above said at least one oblique surface,
the secondary gas diffusers being disposed substantially adjacent to said sidewall.

19. The apparatus as claimed in claim 1 wherein the fibrous material comprises paper and/or cellulose fibres, and said contaminate material includes plastics and adhesive residues.

20. The apparatus as claimed in claim 11 wherein said gas flow includes a mixture of air and/or ozone.

21. The apparatus as claimed in claim 6 further including at least one outlet port formed in said sidewall proximate to said upper edge portion, the outlet ports providing fluid communication between said reservoir and said contaminate waste outlet,
an annular weir member extending inwardly from said sidewall from a lower end spaced below said at least one outlet port, to an upper end vertically above said contaminate waste outlet.

22. The apparatus as claimed in claim 10 further including at least one outlet port formed in said sidewall proximate to said upper edge portion, the outlet ports providing fluid communication between said reservoir and said contaminate waste outlet,
an annular weir member extending inwardly from said sidewall from a lower end spaced below said at least one outlet port, to an upper end vertically above said contaminate waste outlet.

23. The apparatus as claimed in claim 22 wherein the upper end of the weir member is formed with a toothed profile.

24. The apparatus as claimed in claim 22 further including an adjustment member for permitting the selective adjustment in the vertical position of said outlet ports.

25. Use of the apparatus as claimed in claim 1 for separating contaminants from cellulose fibres in a slurry,
wherein said waste stream slurry comprises at least about 90% water and is fed into said reservoir through said infeed opening at a rate selected at between about 0.2 and 5 cubic meters per minute.

26. Use of the apparatus as claimed in claim 25 wherein said slurry comprises a recycled paper slurry and said contaminants comprise plastics and adhesive residues.

27. An apparatus for separating contaminant material from paper or cellulose fibres in a waste stream slurry, the apparatus including,
a reservoir for receiving a volume of said slurry therein, said reservoir including a sidewall extending from a lower edge portion to an upper edge portion,
a slurry infeed opening providing fluid communication between a slurry supply and a lower region of said reservoir,
a contaminate waste outlet spaced toward said upper edge portion and in fluid communication with said reservoir,
at least one baffle member disposed in said reservoir and positioned intermediate said infeed opening and said waste outlet,
at least one fibre discharge passage providing fluid communication between an inlet opening proximate to a selected one of said baffle members and a discharge outlet spaced vertically above said inlet opening, and
a gas nozzle selectively operable to supply a gas flow to said lower region of said reservoir.
